(19) United States
(12) Patent Application Publication
(10) Pub. No.: US 2015/0319621 A1
(43) Pub. Date: Nov. 5, 2015

(54) Method, Apparatus and Computer Program Product for Allocation of a Shared Resource

(71) Applicant: NOKIA SOLUTIONS AND NETWORKS OY, Espoo (FI)

(72) Inventors: Christian MARKWART, Munich (DE); Karl-Josef FRIEDERICHS, Puchheim (DE); Simone REDANA, Munich (DE); Mikko Aleksi UUSITALO, Helsinki (FI)

(73) Assignee: Nokia Solutions and Networks Oy, Espoo (FI)

(21) Appl. No.: 14/439,036

(22) PCT Filed: Oct. 29, 2012
(86) PCT No.: PCT/EP2012/071395

§ 371 Date: Apr. 28, 2015

(51) Int. Cl. H04W 16/14; H04W 36/02; H04W 72/04

(52) U.S. Cl. CPC H04W 16/14; H04W 72/044; H04W 36/02

(57) ABSTRACT

A method including receiving information at a first network node operating with a shared resource; wherein said first network node is enabled to receive said information from one or at least two network nodes; wherein said information includes information enabling said first network node to determine that use of at least a part of said shared resource is one of permitted at said first network node; to be continued at said first network node; to be discontinued at said first network node.

The disclosure relates to methods; apparatus and computer program products and in particular, but not exclusively, to methods, apparatus and computer program products for allocation of a shared resource.

A communication system can be seen as a facility that enables communication sessions between two or more entities such as fixed or mobile communication devices, base stations, servers and/or other communication nodes. A communication system, and compatible communicating entities, typically operate in accordance with a given standard or specification which sets out what the various entities associated with the system are permitted to do and how that should be achieved. For example, the standards, specifications and related protocols can define the manner how various aspects of communication shall be implemented between communicating devices. A communication can be carried on wired or wireless carriers. In a wireless communication system at least a part of communications between stations occurs over a wireless link.

Examples of wireless systems include public land mobile networks (PLMN) such as cellular networks, satellite based communication systems and different wireless local networks, for example wireless local area networks (WLAN). A wireless system can be divided into cells or other radio coverage or service areas. A radio service area is provided by a station. Radio service areas can overlap, and thus a communication device in an area can typically send signals to and receive signals from more than one station.

A user can access the communication system by means of an appropriate communication device. A communication device of a user is often referred to as user equipment (UE) or terminal. A communication device is provided with an appropriate signal receiving and transmitting arrangement for enabling communications with other parties. Typically a communication device is used for enabling receiving and transmission of communications such as speech and data. In wireless systems a communication device provides a transceiver station that can communicate with another communication device such as e.g. a base station or an access point and/or another user equipment. The communication device may access a carrier provided by a station, for example a base station or an access node, and transmit and/or receive communications on the carrier.

An example of communication systems is an architecture that is being standardized by the 3rd Generation Partnership Project (3GPP). This system is often referred to as the long-term evolution (LTE) of the Universal Mobile Telecommunications System (UMTS) radio-access technology. A further development of the LTE is often referred to as LTE-Advanced. The various development stages of the 3GPP LTE specifications are referred to as releases.

A communication system can comprise different types of radio service areas providing transmission/reception points for the users. For example, in LTE-Advanced the transmission/reception points can comprise wide area network nodes such as a macro eNode-B (eNB) which may, for example, provide coverage for an entire cell or similar radio service area. Network nodes can also be small or local radio service area network nodes, for example Home eNBs (HeNB), pico eNodeBs (pico-eNB), or femto nodes. Some applications utilise radio remote heads (RRH) that are connected to for example an eNB. The smaller radio service areas can be located wholly or partially within the larger radio service area. A user equipment may thus be located within, and thus communicate with, more than one radio service area. The nodes of the smaller radio service areas may be configured to support local offload. The local nodes can also, for example, be configured to extend the range of a cell.

A shared access spectrum has been proposed. The shared access spectrum may comprise more than one Mobile Network Operator (MNO) that is authorized to share the available spectrum. Alternatively such shared access spectrums may comprise users other than MNOs e.g. military, emergency services etc. The shared access spectrum may also comprise a combination of such users e.g. a combination of one or more MNOs and military. Such shared access spectrums may be referred to as authorized shared access (ASA) or licensed shared access (LSA).

According to a first aspect there is provided a method comprising: receiving information at a first network node operating with a shared resource; wherein said first network node is enabled to receive said information from one or at least two network nodes; wherein said information comprises information enabling said first network node to determine that use of at least a part of said shared resource is one of permitted at said first network node; to be continued at said first network node; to be discontinued at said first network node.

Said information may be received at the first network node on one or at least two of: a c-plane communication channel; an m-plane communication channel; a communication channel on the X2-interface; an air interface channel; a broadcast channel.

Said shared resource may comprise a shared access spectrum.

Said shared resource may be shared between at least said first network node and a primary user of said shared resource, and wherein said information may indicate a reservation zone which has been reserved by said primary user.

Said primary user may be the owner of said shared resource.

Said reservation zone may comprise one of a geographical area and at least one cell.

Said information may comprise an identifier enabling at least one network node to determine said geographical area to which said information relates.

Said information may comprise information about a resource part to which said information relates.

Said information may comprise a cell-ID.

Said information may comprise timing information enabling said first network node to determine a time that said shared resource is one of: permitted at said first network node; to be continued at said first network node; to be discontinued at said first network node.

When use of said shared resource is to be discontinued by said first network node, said timing information may indicate a time in which said first network node may handover its users of said shared resource.

After expiration of said time in which said first node may handover its users of said shared resource, said first network node may be forced to discontinue use of said shared resource.

Said timing information may comprise an absolute time.

Said information may comprise a transaction identifier enabling said first network node to determine whether said information has already been received at said first network node.

Said first node may be configured to forward said information to at least one further node.

Said first network node may wait a pre-defined time to receive an acknowledgement for the forwarded information, and if no acknowledgement is received in the pre-defined time said first network node may resend the forwarded information or reports an error message.

Said first network node may be configured to acknowledge receipt of said information.

Said first network node may comprises a base station.

In a second aspect there is provided a method comprising: sending information to at least one network node; wherein said information comprises information that use of at least a part of a shared resource is one of permitted; to be continued; to be discontinued by at least one network node; and wherein said information is sent on one or at least two communication channels.

Said information may be sent to the at least one network node on one or at least two of: a c-plane communication channel; an m-plane communication channel; a communication channel on the X2-interface; an air interface channel; a broadcast channel.

Said shared resource may comprise a shared access spectrum.

Said shared resource may be shared between the at least one network node and a primary user of said shared resource, and wherein said information may indicate a reservation zone which has been reserved by said primary user.

Said primary user may be the owner of the shared resource.

Said reservation zone may comprise one of a geographical area and at least one cell.

Said information may comprise an identifier enabling the at least one network node to determine said geographical area to which said information relates.

Said information may comprise information about a resource part to which said information relates.

Said information may comprise a cell-ID.

Said cell-ID may be obtained from a network database.

Said information may comprise timing information as to when said use of said at least one part of the shared resource is one of permitted; to be continued; to be discontinued by at least one network node.

When use of said at least part of the shared resource is to be discontinued by said at least one network node, said timing information may indicate a time in which said at least one network node may handover its users of said shared resource.

After expiration of said time in which said at least one network node may handover its users of said at least part of the shared resource, said at least one network node may be forced to discontinue use of said shared resource.

Said timing information may comprise an absolute time.

Said information may comprise a transaction identifier to enable said at least one network node to determine whether said information has already been received.

The method may comprise receiving an acknowledgement that said sent information has been received by said at least one network node.

If an acknowledgement is not received after a defined time, the information may be either resent to the at least one network node or an error message is reported.

Said information may be sent by an Authorised Shared Access/Licensed Shared Access Control node.

According to a third aspect there is provided an apparatus: said apparatus configured to operate with a shared resource; wherein said apparatus is configured to receive information from one or at least two network nodes; wherein said apparatus is configured to determine from said information that use of at least part of said shared resource is one of: permitted at said apparatus; to be continued at said apparatus; to be discontinued at said apparatus.

Said apparatus may be configured to receive said information on one or at least two of: a c-plane communication channel; an m-plane communication channel; a communication channel on the X2-interface; an air interface channel; a broadcast channel.

Said shared resource with which said apparatus may be configured to operate comprises a shared access spectrum.

Said apparatus may be configured to share said shared resource with a primary user of said shared resource and wherein said information may indicate a reservation zone which has been reserved by said primary user.

Said primary user may be the owner of said shared resource.

Said reservation zone may comprise one of a geographical area and at least one cell.

Said apparatus may be configured to use said information to determine said geographical area to which said information relates.

Said information may comprise information about a resource part to which said information relates.

Said information may comprise a cell-ID.

Said information may comprise timing information, and said apparatus may be configured to use said timing information to determine a time that use of said shared resource is one of permitted at said apparatus; to be continued at said apparatus; to be discontinued at said apparatus.

When use of said shared resource is to be discontinued by said apparatus, said apparatus may be configured to use said timing information to determine a time in which said apparatus may handover its users of said shared resource.

After expiration of said time in which said apparatus may handover its users of said shared resource, said apparatus may be forced to discontinue use of said shared resource.

Said timing information may comprise an absolute time.

Said information may comprise a transaction identifier, said apparatus may be configured to use said transaction identifier to determine whether said information has already been received at said apparatus.

Said apparatus may be configured to forward said information to at least one further node.

Said apparatus may be configured to wait a defined time to receive an acknowledgement for the forwarded information, and if no acknowledgement is received in the defined time said apparatus may be configured to re-send the forwarded information or report an error message.

Said apparatus may be configured to acknowledge receipt of said information.

Said apparatus may comprise a base station.

According to a fourth aspect there is provided an apparatus: wherein said apparatus is configured to send information to at least one network node operating with a shared resource; wherein said information comprises information that use of at least a part of said shared resource is one of: permitted at least one network node; to be continued by at least one network node; to be discontinued by at least one network node; and wherein said apparatus is configured to send said information on one or at least two communication channels.

Said apparatus may be configured to send said information on one or at least two of: a c-plane communication channel; an m-plane communication channel; a communication channel on the X2-interface; an air interface channel; a broadcast channel.

Said shared resource may comprise a shared access spectrum.

Said shared resource may be shared between at least a first node and a primary user of said shared resource, and wherein said apparatus may be configured to include an indicator in said information of a reservation zone which has been reserved by said primary user.

Said primary user may be the owner of said shared resource.

Said reservation zone may comprise one of a geographical area and at least one cell.

Said apparatus may be configured to include an identifier in said information enabling at least one network node to determine said geographical area to which said information relates.

Said apparatus may be configured to provide information about a resource part to which said information relates.

Said information may comprise a cell-ID.

Said apparatus may be configured to obtain said cell-ID from a network database.

Said apparatus may be configured to provide timing information as to when said use of said at least part of the shared resource is one of: permitted at least one network node; to be continued by at least one network node; to be discontinued by at least one network node.

When use of said shared resource is to be discontinued by said at least one network node, said timing information may indicate a time in which said at least one network node may handover its users of said shared resource.

After expiration of said time in which said at least one network node may handover its users of said at least part of the shared resource, said apparatus may be configured to force said at least one network node to discontinue use of said shared resource.

Said timing information may comprise an absolute time.

Said apparatus may be configured to provide a transaction identifier associated with said information to enable said at least one network node to determine whether said information has already been received.

Said apparatus may be configured to receive an acknowledgement that said sent information has been received by said at least one network node.

If said acknowledgement is not received after a pre-defined time, the apparatus may be configured to re-send the information or report an error message.

Said apparatus may comprise an Authorised Shared Access/Licensed Shared Access Control node.

According to a fifth aspect there is provided an apparatus: said apparatus comprising means enabling said apparatus to operate with a shared resource; wherein said apparatus comprises means for receiving information from one or at least two network nodes; wherein said apparatus comprises means for determining from said information that use of at least part of said shared resource is one of: permitted at said apparatus; to be continued at said apparatus; to be discontinued at said apparatus.

Said apparatus may comprise means for receiving said information on one or at least two of: a c-plane communication channel; an m-plane communication channel; a communication channel on the X2-interface; an air interface channel; a broadcast channel.

Said shared resource with which said apparatus is enabled to operate may comprise a shared access spectrum.

Said apparatus may comprise means for sharing said shared resource with a primary user of said shared resource and wherein said information may indicate a reservation zone which has been reserved by said primary user.

Said primary user may be the owner of said shared resource.

Said reservation zone may comprise one of a geographical area and at least one cell.

Said apparatus may comprise means for using said information to determine said geographical area to which said information relates.

Said information may comprise information about a resource part to which said information relates.

Said information may comprise a cell-ID.

Said information may comprise timing information, and said apparatus may comprise means for using said timing information to determine a time that use of said shared resource is one of permitted at said apparatus; to be continued at said apparatus; to be discontinued at said apparatus.

When use of said shared resource is to be discontinued by said apparatus, said apparatus may comprise means for using said timing information to determine a time in which said apparatus may handover its users of said shared resource.

After expiration of said time in which said apparatus may handover its users of said shared resource, said apparatus may be forced to discontinue use of said shared resource.

Said timing information may comprise an absolute time.

Said information may comprise a transaction identifier, said apparatus may comprise means for using said transaction identifier to determine whether said information has already been received at said apparatus.

Said apparatus may comprise means for forwarding said information to at least one further node.

Said apparatus may comprise a means for waiting a defined time to receive an acknowledgement for the forwarded information, and if no acknowledgement is received in the defined time said apparatus may comprise a means for re-sending the forwarded information or for reporting an error message.

Said apparatus may comprise means for acknowledging receipt of said information.

Said apparatus may comprise a base station.

According to a sixth aspect there is provided an apparatus: wherein said apparatus comprises means for sending information to at least one network node operating with a shared resource; wherein said information comprises information that use of at least a part of said shared resource is one of: permitted at least one network node; to be continued by at least one network node; to be discontinued by at least one network node; and wherein said apparatus comprises means for sending said information on one or at least two communication channels.

Said apparatus may comprise means for sending said information on one or at least two of: a c-plane communication channel; an m-plane communication channel; a communication channel on the X2-interface; an air interface channel; a broadcast channel.

Said shared resource may comprise a shared access spectrum.

Said shared resource may be shared between at least a first node and a primary user of said shared access spectrum, and wherein said apparatus may comprise means for including an indicator in said information of a reservation zone which has been reserved by said primary user.

Said primary user may be the owner of said shared resource.

Said reservation zone may comprise one of a geographical area and at least one cell.

Said apparatus may comprise means for including an identifier in said information enabling at least one network node to determine said geographical area to which said information relates.

Said apparatus may comprise means for providing information about a resource part to which said information relates.

Said information may comprise a cell-ID.

Said apparatus may comprise means for obtaining said cell-ID from a network database.

Said apparatus may comprise means for providing timing information as to when said use of said at least part of the shared resource is one of: permitted at least one network node; to be continued by at least one network node; to be discontinued by at least one network node.

When use of said shared resource is to be discontinued by said at least one network node, said timing information may indicate a time in which said at least one network node may handover its use of said shared resource.

After expiration of said time in which said at least one network node may handover its users of said at least part of the shared resource, said apparatus may comprise means for forcing said at least one network node to discontinue use of said shared resource.

Said timing information may comprise an absolute time.

Said apparatus may comprise means for providing a transaction identifier associated with said information to enable said at least one network node to determine whether said information has already been received.

Said apparatus may comprise means for receiving an acknowledgement that said sent information has been received by said at least one network node.

If said acknowledgement is not received after a pre-defined time, the apparatus may comprise means for re-sending the information or for reporting an error message.

Said apparatus may comprise an Authorised Shared Access/Licensed Shared Access Control node.

According to a seventh aspect there is provided a system comprising: an apparatus configured to send information to at least one network node operating with a shared resource; at least one network apparatus configured to receive said information and to determine whether use of at least part of said shared resource is one of: permitted at said network apparatus; to be continued at said network apparatus; to be discontinued at said network apparatus.

According to an eighth aspect there is provided a computer program comprising computer executable instructions which when run on one or more processors perform the method as set forth in the first aspect, in any of its variations.

According to a ninth aspect there is provided a computer program comprising computer executable instructions which when run on one or more processors perform the method as set forth in the second aspect, in any of its variations.

According to a tenth and eleventh aspect, an apparatus may comprise at least one processor and at least one memory comprising computer program code. The at least one memory and the computer program code may be configured to, with the at least one processor, cause the apparatus at least to perform the method as set forth in the first or the second aspects, in any of their variations.

According to twelfth and thirteenth aspects, a computer program product may comprise instructions to perform a process. The process may comprise the method as set forth in the first or second aspects, in any of their variations.

According to fourteenth and fifteenth aspects, a non-transitory computer readable medium may be encoded with instructions that, when executed in hardware, perform a process. The process may comprise the method as set forth in the first or second aspects, in any of their variations.

According to sixteenth and seventeenth aspects, a computer program may comprise code for performing the method set forth in the first or second aspect above, in any of their variations, when the computer program is run on a processor. The computer program may be a computer program product. A computer program product may, in several embodiments, comprise a computer readable medium encoded with instructions that, when executed in hardware, perform a process. The process may comprise the method of the first and/or the second embodiment above.

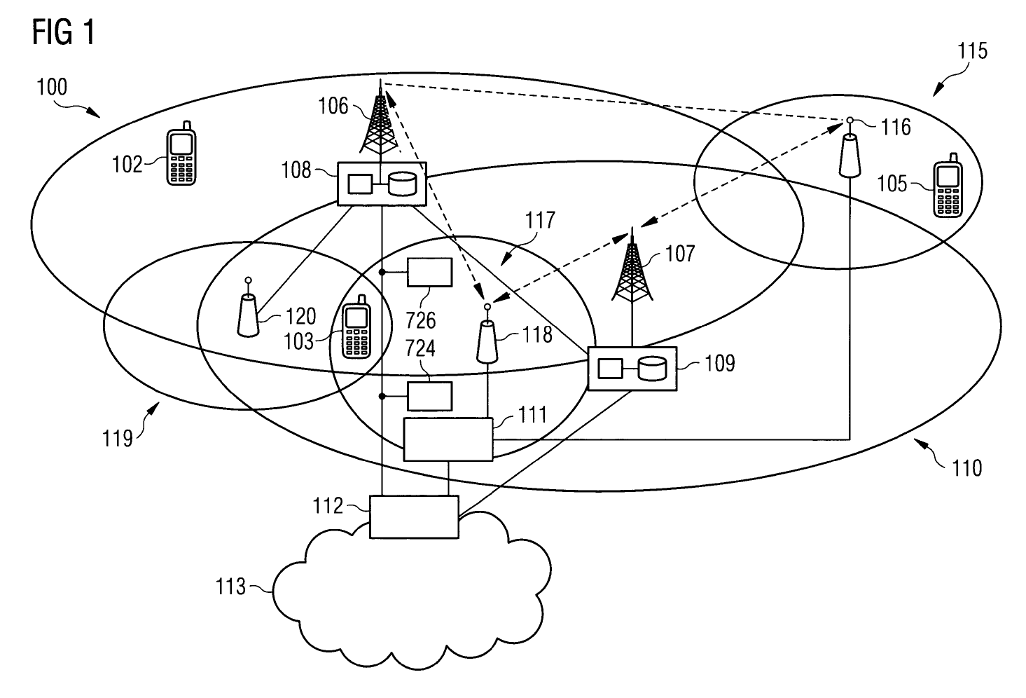

FIG. 1 shows a schematic diagram of a network according to some embodiments;

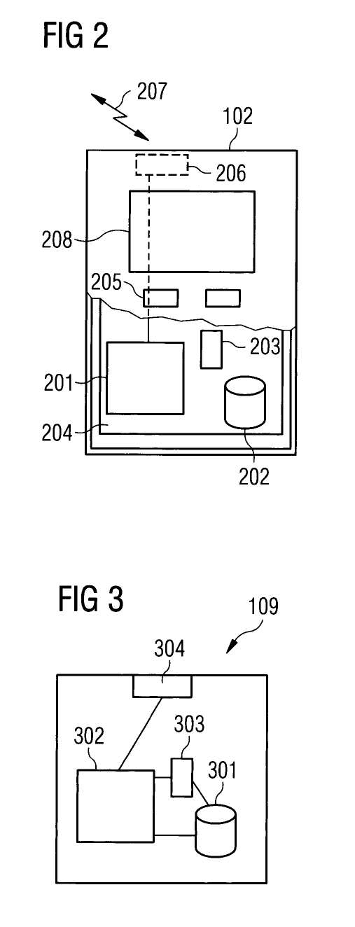

FIG. 2 shows a schematic diagram of a mobile communication device according to some embodiments;

FIG. 3 shows a schematic diagram of a control apparatus according to some embodiments;

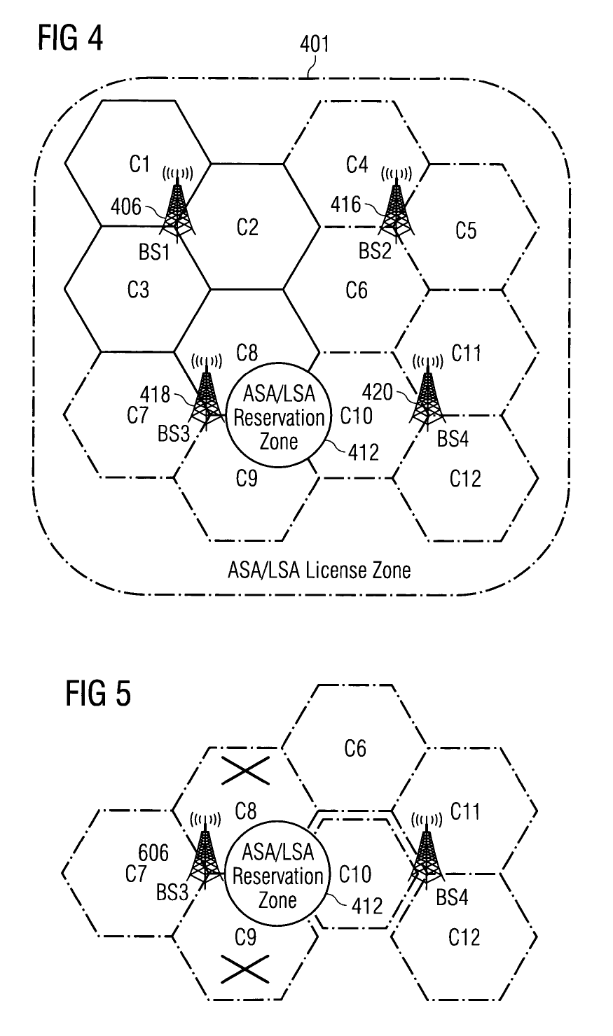

FIG. 4 shows a cellular network comprising an ASA/LSA reservation zone;

FIG. 5 shows a portion of a cellular network comprising an ASA/LSA reservation zone;

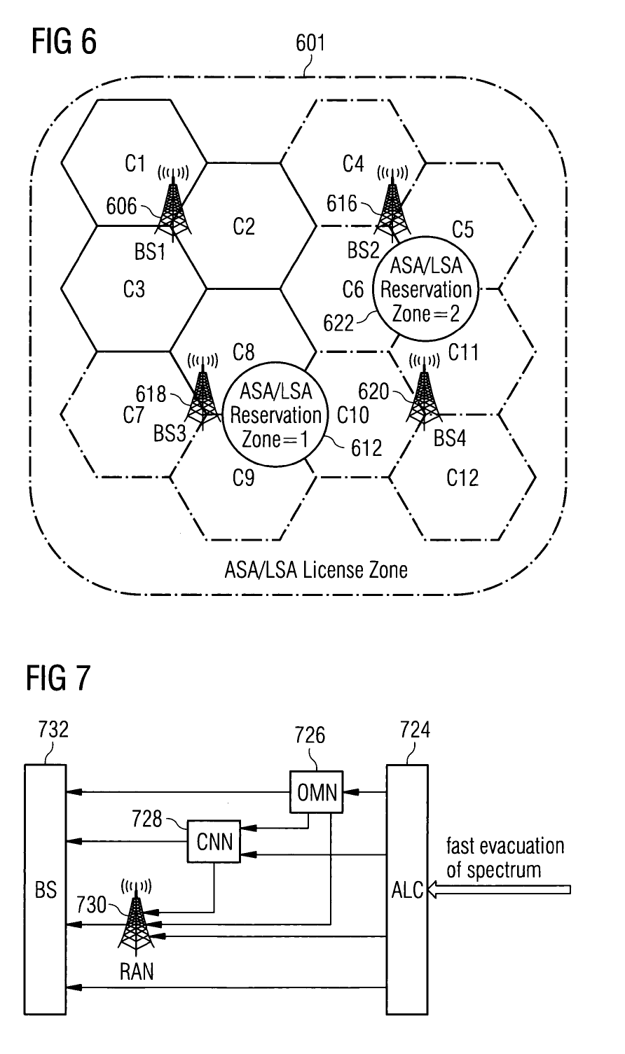

FIG. 6 shows a cellular network comprising two ASA/LSA reservation zones;

FIG. 7 shows certain components of an access system according to one embodiment;

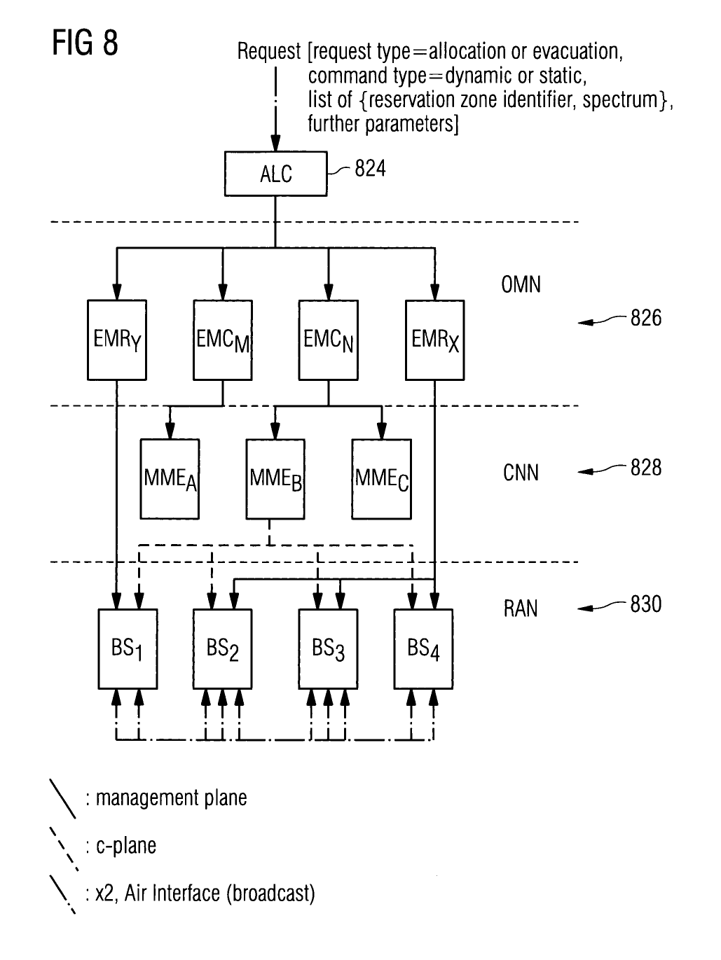

FIG. 8 shows certain components of an access system according to one embodiment;

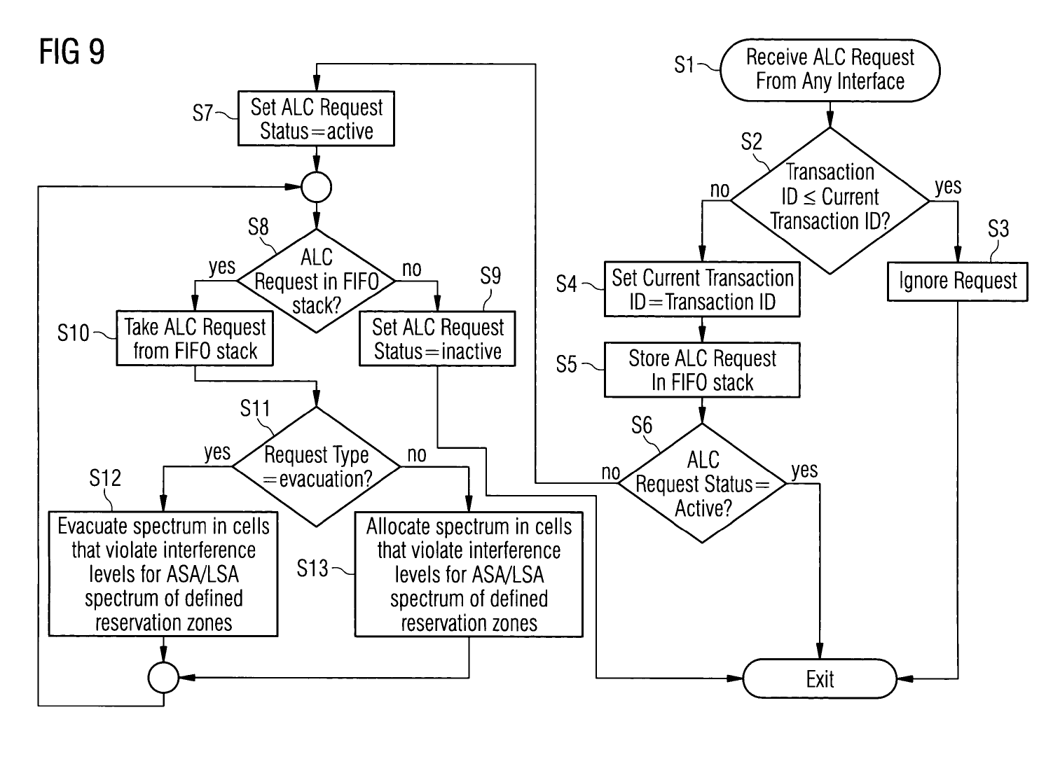

FIG. 9 is a flow chart according to one embodiment.

In the following certain exemplifying embodiments are explained with reference to a wireless or mobile communication system serving mobile communication devices. Before explaining in detail the exemplifying embodiments, certain general principles of a wireless communication system and mobile communication devices are briefly explained with reference to FIGS. 1 to 3 to assist in understanding the technology underlying the described examples.

In a wireless communication system mobile communication devices or user equipments (UE) 102, 103, 105 are provided wireless access via at least one base station or similar wireless transmitting and/or receiving node or point. In the FIG. 1 example two overlapping access systems or radio service areas of a cellular system 100 and 110 and three smaller radio service areas 115, 117 and 119 provided by base stations 106, 107, 116, 118 and 120 are shown. Each mobile communication device and station may have one or more radio channels open at the same time and may send signals to and/or receive signals from more than one source. It is noted that the radio service area borders or edges are schematically shown for illustration purposes only in FIG. 1. It shall also be understood that the sizes and shapes of radio service areas may vary considerably from the shapes of FIG. 1. A base station site can provide one or more cells. A base station can also provide a plurality of sectors, for example three radio sectors, each sector providing a cell or a subarea of a cell. All sectors within a cell can be served by the same base station.

Base stations are typically controlled by at least one appropriate controller apparatus so as to enable operation thereof and management of mobile communication devices in communication with the base stations. In FIG. 1 control apparatus 108 and 109 is shown to control the respective macro level base stations 106 and 107. The control apparatus of a base station can be interconnected with other control entities. The control apparatus is typically provided with memory capacity and at least one data processor. The control apparatus and functions may be distributed between a plurality of control units.

In FIG. 1 stations 106 and 107 are shown as connected to a wider communications network 113 via gateway 112. A further gateway function may be provided to connect to another network. The smaller stations 116, 118 and 120 can also be connected to the network 113, for example by a separate gateway function and/or via the controllers of the macro level stations. In the example, stations 116 and 118 are connected via a gateway 111 whilst station 120 connects via the controller apparatus 108.

Also shown in FIG. 1 are ASA/LSA control node (ALC) 724 and Operation Administration and Maintenance node 726. These are explained in more detail further below.

A possible mobile communication device for transmitting and retransmitting information blocks towards the stations of the system will now be described in more detail in reference to FIG. 2 showing a schematic, partially sectioned view of a communication device 102. Such a communication device is often referred to as user equipment (UE) or terminal. An appropriate mobile communication device may be provided by any device capable of sending and receiving radio signals. Non-limiting examples include a mobile station (MS) such as a mobile phone or what is known as a ‘smart phone’, a computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information. The mobile device 102 may receive signals over an air interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A wireless communication device can be provided with a Multiple Input/Multiple Output (MIMO) antenna system. MIMO arrangements as such are known. MIMO systems use multiple antennas at the transmitter and receiver along with advanced digital signal processing to improve link quality and capacity. Although not shown in FIGS. 1 and 2, multiple antennas can be provided, for example at base stations and mobile stations, and the transceiver apparatus 206 of FIG. 2 can provide a plurality of antenna ports. More data can be received and/or sent where there are more antenna elements. A station may comprise an array of multiple antennas. Signalling and muting patterns can be associated with Tx antenna numbers or port numbers of MIMO arrangements.

A mobile device is also typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

FIG. 3 shows an example of a control apparatus for a communication system, for example to be coupled to and/or for controlling a station of an access system, such as a base station. In some embodiments the control apparatus may be part of a base station. In some embodiments base stations comprise a separate control apparatus. In other embodiments the control apparatus can be another network element. The control apparatus 109 can be arranged to provide control on communications in the service area of the system. The control apparatus 109 can be configured to provide control functions in association with generation and communication of request and instructions in view of reception of information blocks, retransmissions and other related information by means of the data processing facility in accordance with certain embodiments described below. For this purpose the control apparatus 109 comprises at least one memory 301, at least one data processing unit (or processor or microprocessor) 302, 303 and an input/output interface 304. Via the interface the control apparatus can be coupled to a receiver and a transmitter. The receiver and/or transmitter may be part of a base station. That is the apparatus may comprise means for receiving and means for sending/transmitting. The control apparatus 109 can be configured to execute an appropriate software code to provide the control functions. It shall be appreciated that similar components can be provided in a control apparatus provided elsewhere in the system for controlling reception of sufficient information for decoding of received information blocks.

Although FIG. 3 shows one memory 301 and two processors 302 and 303, any number of these components may be provided. Multiple functions may be carried out in a single processor, or separate functions may be carried out by separate processors. For example a single processor may be used to make multiple determinations (e.g. whether to continue or discontinue an action, determination of a geographical area or timing information etc.), or these determinations may be made by separate processors.

The communication devices 102, 103, 105 can access the communication system based on various access techniques, such as code division multiple access (CDMA), or wideband CDMA (WCDMA). Other examples include time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

As will be discussed in more detail below, a control apparatus such as that shown in FIG. 3 may be configured to enable fast evacuation of a shared resource.

A non-limiting example of the recent developments in communication system architectures is the long-term evolution (LTE) of the Universal Mobile Telecommunications System (UMTS) that is being standardized by the 3rd Generation Partnership Project (3GPP). As explained above, further development of the LTE is referred to as LTE-Advanced. Non-limiting examples of appropriate LTE access nodes are a base station of a cellular system, for example what is known as NodeB (NB) in the vocabulary of the 3GPP specifications. The LTE employs a mobile architecture known as the Evolved Universal Terrestrial Radio Access Network (E-UTRAN). Base stations of such systems are known as evolved or enhanced Node-Bs (eNBs) and may provide E-UTRAN features such as user plane Radio Link Control/Medium Access Control/Physical layer protocol (RLC/MAC/PHY) and control plane Radio Resource Control (RRC) protocol terminations towards the user devices. Other examples of radio access system include those provided by base stations of systems that are based on technologies such as wireless local area network (WLAN) and/or WiMax (Worldwide Interoperability for Microwave Access).

Base stations 106, 107, 116, 118 and 120 may be enabled to use ASA (authorized shared access) spectrum, also known as LSA (licensed shared access) spectrum to extend the capacity for broadband wireless access. In addition those base stations may also support other access spectrums in parallel, for example licensed spectrum. ASA/LSA is a complementary way of authorising spectrum usage, in addition to licensed and license-exempt (unlicensed), see e.g. EU RSPG: Report on Collective Use of Spectrum (CUS) and other spectrum sharing approaches RSPG11-392.

ASA/LSA spectrum is typically owned by an “incumbent” (primary user) who allows others, for example licensed operators (secondary user) to use this spectrum for their purpose. ASA/LSA may allow support of different operators by using separated ASA/LSA resources. Each ASA/LSA resource may be defined by a spectrum part and a corresponding time interval and location where this spectrum part may be used.

In mobile networks spectrum utilization and allocation may be performed via static configurations based on network planning data of a Mobile Network Operator (MNO). With the introduction of ASA/LSA it may no longer be possible to stay with these static configurations because the ASA/LSA spectrum may need to be evacuated by secondary users according to predefined terms and conditions if requested by the incumbent (primary user). Therefore the principle of “my spectrum—my usage” may not hold any longer. In other words it may be desirable for the known static spectrum allocation methods to be complemented. In addition to the traditional exclusive spectrum assignment there is now also a situation where (in some regions) certain parts of the spectrum may no longer be exclusively assigned to a single operator but may be jointly assigned to two or more operators with the obligation to use it collectively. It should be noted that the term “operator” is not limited to a Mobile Network Operator but can refer to any user operating in the shared spectrum area.

A characteristic of ASA/LSA is that the incumbent may reserve an ASA/LSA resource for its own usage. Such reservations may be defined by static rules (e.g. a defined zone and/or time where the spectrum is used by the incumbent) or dynamic rules (e.g. evacuation of spectrum currently used by MNO on request from the incumbent for emergency situations). In both cases zones where the spectrum use under ASA/LSA is not allowed may be defined by geographical area, time and transmitter/receiver characteristics. Additionally the evacuation lead time i.e. the time between initializing the request to free up the ASA/LSA spectrum zone and the finalization of the spectrum evacuation, may be defined as another input parameter to the Operator.

The Operator has to perform appropriate measures in the network, e.g. re-configurations or switch off ASA/LSA spectrum of specific Base Stations without violating the evacuation lead time in case of spectrum resource reservation actions triggered by the incumbent. Typically such measures can be realized since the location and behaviour of each Operator Base Station and the reservation zones may be known and can be used in a planning process to get the information needed to perform reservation actions.

FIG. 4 shows an example scenario comprising an ASA/LSA license zone 401 with four base stations 406, 416, 418 and 420. Each base station is a 3-sector base station i.e. each base station services three cells. Base station 406 services cells C1, C2 and C3. Base station 416 services cells C4, C5 and C6. Base station 418 services cells C7, C8 and C9. Base station 420 services cells C10, C11 and C12. It should be understood that the system shown in FIG. 4 is by way of example only and that the license zone 401 may comprise any number of cells, and that each base station may serve any number of those cells.

Within the ASA/LSA license zone 401 the incumbent or primary user may define a reservation zone 412 which, upon request, needs to be evacuated. That is all users other than the incumbent user must discontinue using the otherwise shared spectrum in the event that the incumbent or primary user needs or requests exclusive use of the spectrum in the reservation zone 412.

In the example embodiment shown in FIG. 4 cells C8, C9 and C10 are affected by the reservation zone 412. The MNO may use input information to determine the affected cells C8, C9 and C10, and may derive the measures for evacuation. In this embodiment the MNO may decide to switch off the ASA/LSA spectrum for cells C8 and C9, and to reconfigure cell C10 to reduce its size.

FIG. 5 shows an example of the implemented ASA/LSA reservation zone 412 after evacuation thereof by the secondary users. The cells C8 and C9 are no longer able to use the shared spectrum as schematically denoted by the crosses in those cells, and cell size C10 has been reduced so that it no longer overlaps with ASA/LSA reservation zone 412.

In some cases allocation and de-allocation of the ASA/LSA spectrum may be not time critical. However there are some cases, e.g. spectrum use for public safety and defence, where fast evacuation of ASA/LSA spectrum may be a “hard” or important requirement. In the case of an emergency the spectrum should be available as soon as possible to the primary user.

A network initiated handover procedure may not be quick enough to satisfy the fast evacuation “hard” requirement. Regional evacuation Operation Administration & Maintenance (OAM) methods may be used but this may require vendor specific implementations, which may increase cost and complexity.

As per FIG. 4, FIG. 6 shows an example of a radio access network (RAN) which consists of 12 cells (C1 to C12). As shown in FIG. 6 there are two predefined ASA/LSA reservation zones 612 and 622. The ASA/LSA reservation zone 612 overlaps with cells C8, C9 and C10. Therefore base stations 618 and 620 will be affected by an evacuation or allocation command for the ASA/LSA spectrum in reservation zone 612. Reservation zone 622 overlaps with cells C5, C6 and C11. Therefore base stations 616 and 620 are affected by reservation zone 622. This relationship may be preconfigured at each base station by the operator using standardised OAM systems. That is each base station may locally store the following information, or at least parts of the following information:

TABLE 1

| | | Affects |
|---|---|---|
| | | Reservation |
| Base Station | Cell | Zone |
| BS1 (606) | C1 | — |
| | C2 | — |
| | C3 | — |
| BS2 (616) | C4 | — |
| | C5 | RZ2 (622) |
| | C6 | RZ2 (622) |
| BS3 (618) | C7 | — |
| | C8 | RZ1 (612) |
| | C9 | RZ1 (612) |
| BS4 (620) | C10 | RZ1 (612) |
| | C11 | RZ2 (622) |
| | C12 | — |

Each base station 606, 616, 618 and 620 therefore is aware of which (if any) ASA/LSA reservation zones are present in its cells. In some embodiments each reservation zone defined by the incumbent is identified by a unique evacuation zone code or identification code. The incumbent may split the spectrum in to different parts. In such a case the specific spectrum part may also be addressed. In some embodiments this is done by adding the spectrum part information as an additional parameter to the evacuation command or by combining the spectrum part with the reservation zone to a single identification code. Further the information in Table 1 may comprise information about the actions to be performed for example in a spectrum evacuation situation (for example switching the affected cell(s) off or making the affected cell(s) smaller).

Methods may be used other than evacuation zone codes or identification codes. That is the information informing the base stations to evacuate the reservation zone may be conveyed in any way. The information may be conveyed in more than one message, and re-constructed at the one or more base stations. In some embodiments the message to the base station may be a direct instruction to evacuate the reservation zone, without the use of codes.

As shown in the example Table 1 above, the base stations may be provided with information enabling each base station to decide whether an evacuation command is relevant to that base station, and how to react on receipt of a command (e.g. switching cell off in case of an evacuation command, not shown in Table 1). Each base station may be provided with or assigned a list of evacuation zone codes (or identification codes). The list may include all reservation zones that are interfered with by the base station when using the ASA/LSA spectrum.

Alternatively a list of cell IDs that affect a reservation zone may be stored for each evacuation zone code or identification code at a network repository. This information may be stored for example in a database. The ALC may then use the network repository to identify the base stations (which can be identified using the stored cell IDs) in which the ASA/LSA spectrum needs to be evacuated. In this case the evacuation command may replace the evacuation zone codes with the cell IDs from the network repository.

A base station receiving the evacuation command may start the evacuation of the zones corresponding to the evacuation zone codes or identification codes included in the evacuation command i.e. it may check whether or not the evacuation zone codes or the identification codes are in the assigned list. If “yes” the BS may begin spectrum evacuation, possibly based on the instructions (shut cell down or make it smaller) which may for example be comprised in the list or received with the command.

The evacuation zone codes or identification codes may be associated with an absolute time by which the evacuation should be performed. This allows the prioritisation of evacuation of specific ASA/LSA spectrum parts or reservation zones. The evacuation zone codes or identification codes may also contain information of when the evacuation is to start. This may be useful for an evacuation scheduled to take place in the future. Additional timer information may be added to the evacuation command. The additional timer may be used to define the time interval in which graceful handovers (HO) of users to Operator owned spectrum may be performed before the hard evacuation of the ASA/LSA spectrum (e.g. switch off). The evacuation command may be used to trigger HO from UE, BS, CN before switching off the ASA/LSA spectrum.

In embodiments comprising a network database which may comprise the ASA/LSA spectrum and the reservation zone information and also the base station with its assigned evacuation zone codes or identification codes, it may be possible for each network element to optimize the distribution of the evacuation commands i.e. each network element may check if a command needs to be forwarded or not.

In some embodiments the method may also be beneficial for ASA/LSA spectrum assignment as well as fast spectrum evacuation.

A fast evacuation of the ASA/LSA spectrum in reservation zones 612 and 622 may be initiated by the incumbent (i.e. owner of the ASA/LSA spectrum) via a web interface.

FIG. 7 shows in general terms an example system architecture for enabling fast evacuation.

There is shown in FIG. 7 an ASA/LSA control entity 724. When the fast evacuation command is initiated by the incumbent the command may include a set of parameters (e.g. identifying the ASA/LSA spectrum, ASA/LSA reservation zones, evacuation time, and options). The evacuation request maybe in the following form:

Request [evacuation, static, {RZ1, LSA spectrum, RZ2, LSA spectrum}-]

where the parameter “static” defines that RZ1 and RZ2 represent the reservation zone identifiers (evacuation codes) and in some embodiments no further information may be added. In some embodiments the evacuation command may be broadcast to part of the network or the entire network thus enabling either one, or a set of, or all possible communication channels from the operator network to the base station to be utilised i.e. a common command for all base stations. As shown in Table 1 above, each base station may be configured in a way that the base station can decide along with the corresponding parameters of the evacuation command whether the evacuation command is relevant for that base station or can be ignored.

In FIG. 7 the various example routes/paths, via which the command may be sent from the ALC entity 724 to the Base Station 732 are shown. The command may be either sent directly from the ALC 724 to the BS 732 or indirectly via other nodes like OAM management node (OMN) 726, core network node (CNN) 728 and radio access node (RAN) 730. A target of each node is to receive the command, to adapt the command to one or several new channels/paths that may be supported by the respective node and to forward the adapted command to the BS 732. A further aspect may be that a node (e.g. OMN 726) may use a direct route/path to BS 732 or further indirect routes/paths via nodes (e.g. CNN 728 or RAN 730) to forward the adapted command to the BS 732. In general the nodes, which may be used to forward the adapted command, may be configured in a way to avoid that a forwarded command is circulated in the Network without reaching the BS 732. For example, one approach may introduce a hierarchical order for the Network types, where BS 732 may represent the lowest class and ALC 724 may represent the highest class, and to for example allow a node to address only nodes of equal and/or lower classified node types. For example a node that belongs to the class CNN may be allowed to forward the adapted command to other nodes of the CNN class, other nodes of the RAN class and to the BS but the node may not be allowed to forward the command to nodes of higher classes, i.e. the OMN class or the ALC.

FIG. 8 shows an example of a hierarchical structure of a mobile operator network with several nodes according to some embodiments. FIG. 8 demonstrates the path that the evacuation command may take to reach the base stations. In this embodiment the hierarchy order starts with the ALC 824 as the highest class, followed by the OMN class, followed by the CNN class and finally the RAN (lowest) class which consists of the addressed target base stations BS1, BS2, BS3 and BS4. As shown in FIG. 8 the ALC 824 may receive the evacuation request from the incumbent. The ALC 824 may forward the request to OAM management nodes shown generally at 826. The OAM management nodes 826 consist of nodes EMR_{Y}, EMC_{M}, EMC_{N} and EMR_{X}, where EMR refers to an Element Manager for Radio Systems node and EMC refers to an Element Manager for Core Network node.

The core network nodes are shown generally at 828. These consist of core network nodes MME_{A}, MME_{B}, and MME_{C}, where MME refers to a Mobility Management Entity. OAM management node EMC_{M} may forward the evacuation request to MME_{A}. OAM management node EMC_{M} may forward the evacuation request to core network nodes MME_{B} and MME_{C}.

The RAN nodes are shown generally at 830. These consist of RAN node BS1, BS2, BS3 and BS4. OAM management node EMR_{Y} may forward the request directly to BS1, bypassing the core network nodes 828. OAM node EMR_{X} may forward the request to RAN nodes BS2, BS3 and BS4, bypassing the core network nodes 828.

Core network nodes 828 may also forward the evacuation request to RAN nodes 830. Each of the core network nodes MME_{A}, MME_{B} and MME_{C} may forward the evacuation request to each of RAN nodes BS1, BS2, BS3 and BS4.

The RAN nodes BS1, BS2, BS3 and BS4 may also inform each other of the evacuation request.

In this embodiment the message may be sent from the ALC to the OAM nodes 826 on the management plane. Likewise the messages may be sent from the OAM nodes 826 to the core network nodes 828 on the management plane. The messages may be sent from the core network nodes 828 to the RAN node 830 on the control plane. Communication between the RAN nodes 830 may occur on the X2 or air interface.

The core network nodes 828 may also inform the RAN nodes 830 via the S1 protocol about the ASA/LSA spectrum evacuation. This may be done by adding the information to existing S1 messages or by introducing a new S1 message for the evacuation.

As will be appreciated, each of BS1, BS2, BS3 and BS4 may receive the evacuation command a number of times. For example BS2 may receive the evacuation message from the OAM node EMR_{X}. It may also receive the evacuation message from MME_{B}, and it may also receive the evacuation message from each of BS1, BS3 and BS4. Further evacuation commands may also be received from other MMEs according to the number of currently active S1 signalling end points. To avoid multiple processing of the evacuation requests in some embodiments the use of an ascending sequence of transaction IDs may be implemented at each base station. Using this system each base station may identify whether the evacuation request is a new request which should be acted upon, or a duplicate of an already received request.

In some embodiments, to avoid multiple success messages in the network, each element or node in FIG. 8 may acknowledge received evacuation commands only to the direct neighbour that has sent or forwarded the evacuation command. When the base station has successfully processed the evacuation a confirmation may be generated and may be forwarded to the OAM system and subsequently to the ALC. Likewise, if a fault occurs (e.g. no graceful evacuation was possible) an alarm may be generated and may be forwarded to the OAM system and subsequently to the ALC.

In the event that an acknowledgement may not be received, one of the nodes of FIG. 8 may send again the evacuation command after the expiration of a timer, which is preferably configurable. In some embodiments a number of retries may be set, which is preferably configurable. If this number of retries is not successful i.e. no acknowledgement received, the network element may generate an alarm to inform the OAM and hence the ALC that evacuation via the respective communication channel is not possible.

It should be appreciated that FIG. 8 shows one particular embodiment, and modifications may be envisaged. For example the communications between the various levels (ALC 824, OMN 826, CNN 828 and RAN 830) might take place on any plane e.g. management plane, control plane, X2, air interface, or a mixture thereof. That is the communications may be not limited to the planes shown in FIG. 8. The manner in which the message is processed and forwarded at each level may also be varied. For example OMN node EMR_{Y} may be also capable of forwarding the message to one or more core network nodes MME_{A}, MME_{B}, or MME_{C} and/or one or more OAM management nodes EMC_{M}, EMC_{N}, or EMR_{X}. There may of course also be any number of nodes at each level.

A method and use of transaction numbers is shown in FIG. 9.

FIG. 9 is an example flow chart showing the operation in a base station upon receipt of an evacuation request. At step S1 the evacuation request may be received. This may be received from any interface e.g. ALC 824, OMN 826, or CNN 828 or via a plurality of these interfaces as described with respect to FIG. 8.

At step S2 the base station may determine the transaction ID or number. In particular a determination may be made as to whether the latest received transaction ID is less than or equal to the transaction ID currently stored in the base station memory. If the answer is “yes” then the base station may determine that the request is a duplicate of an earlier request, and accordingly may ignore it at step S3 so as to exit the flow.

If the determination at step S2 is “no” then the base station may determine that the request is a new request and at step S4 the base station may set the newly received transaction ID as the transaction ID in the base station memory.

At step S5 the base station may also store the ALC request in a first in first out (FIFO) stack. In case that the optional timer information (for execution of the ALC request) may be used the FIFO principle may be modified to guarantee that the execution order of the ALC requests is in the correct time order. The modified FIFO principle may then also be used at step S10.

At step S6 a determination may be made as to whether any ALC request is “active”. By this is meant whether there is a former ALC request which the system may be already acting upon. If the answer is “yes” then the flow may be exited.

If the determination at step S6 is “no” then the process may continue to step S7 where the request status may be set to “active”. The next step is step S8 where a determination may be made as to whether the ALC request is in the FIFO stack. If the answer is “no” then the procedure may continue to step S9 where the ALC request status may be set to “inactive” and the process is subsequently exited.

If on the other hand the determination at step S8 is “yes” then the next request may be taken from the FIFO stack at step S10 and the process continues to step S11.

At step S11 a determination may be made as to whether the request type is an evacuation request. If the determination at step S11 is “yes” then at step S12 evacuation may be carried out for the spectrum in the cells that violate interference levels for the ASA/LSA spectrum of defined reservation zones.

If, on the other hand, it is not an evacuation request, then the process proceeds to step S13 where the spectrum may be allocated to the base station for the ASA/LSA spectrum of defined reservation zones.

In the embodiment of FIG. 9 an ascending sequence mechanism is used. It should be appreciated that in other embodiments a descending sequence mechanism may be used. When a descending sequence mechanism is used step S2 becomes:

Transaction ID≧Current Transaction ID?

It can thus be appreciated that some embodiments of the present invention may facilitate fast evacuation of an ASA/LSA spectrum. In embodiments where the evacuation command is broadcast, a single message may be used to initiate an evacuation of defined ASA/LSA resources at base station nodes and User terminals (UEs). Also, by using multiple channels in parallel the message may reach the relevant nodes via the fastest route (which may not be easy to determine at the time of sending the message). Embodiments may also help to overcome local overload situations or even outages of network sub-components.

Embodiments may also be implemented in centralized and decentralized structures. Each node may be capable of performing one, more or all of the operations described. Each node (e.g. ALC, base station, EMR, EMC, MME etc.) may comprise some or all of the components described with respect to FIG. 3.

Since the embodiments may operate using standardised interfaces then they can be easily integrated into current networks. Embodiments also support high availability for spectrum evacuation and allocation even if the mobile network is based on a standard reliability implementation.

It should also be appreciated that although a shared access spectrum is discussed, embodiments may also be applicable to other shared resources. For example multiple operators may share for example resources like backhaul capacity, CPU load, concurrent user capacity etc.

An appropriately adapted computer program code product or products may be used for implementing the embodiments, when loaded on an appropriate data processing apparatus, for example for determining geographical boundary based operations and/or other control operations. The program code product for providing the operation may be stored on, provided and embodied by means of an appropriate carrier medium. An appropriate computer program can be embodied on a computer readable record medium. A possibility is to download the program code product via a data network. In general, the various embodiments may be implemented in hardware or special purpose circuits, software, logic or any combination thereof. Embodiments of the inventions may thus be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

It is also noted herein that while the above describes exemplifying embodiments of the invention, there are several variations and modifications which may be made to the disclosed solution without departing from the scope of the present invention.

1. A method comprising:
receiving information at a first network node operating with a shared resource;
wherein said first network node is enabled to receive said information from one or at least two network nodes;
wherein said information comprises information enabling said first network node to determine that use of at least a part of said shared resource is one of permitted at said first network node; to be continued at said first network node; to be discontinued at said first network node.

2. A method as set forth in claim 1, wherein said information is received at the first network node on one or at least two of: a c-plane communication channel; an m-plane communication channel; a communication channel on the X2-interface; an air interface channel; a broadcast channel.

3. A method as set forth in claim 1, wherein said shared resource comprises a shared access spectrum.

4. A method as set forth in claim 1, wherein said shared resource is shared between at least said first network node and a primary user of said shared resource, and wherein said information indicates a reservation zone which has been reserved by said primary user.

5. A method as set forth in claim 1, wherein said information comprises information about a resource part to which said information relates.

6. A method as set forth in claim 1, wherein said information comprises timing information enabling said first network node to determine a time that said shared resource is one of: permitted at said first network node; to be continued at said first network node; to be discontinued at said first network node.

7. A method as set forth in claim 6 wherein when use of said shared resource is to be discontinued by said first network node, said timing information indicates a time in which said first network node may handover its users of said shared resource.

8. A method as set forth in claim 1, wherein said information comprises a transaction identifier enabling said first network node to determine whether said information has already been received at said first network node.

9. A method comprising:
sending information to at least one network node;
wherein said information comprises information that use of at least a part of a shared resource is one of permitted; to be continued; to be discontinued by at least one network node;
and wherein said information is sent on one or at least two communication channels.

10. A method as set forth in claim 9, wherein said information is sent to the at least one network node on one or at least two of: a c-plane communication channel; an m-plane communication channel; a communication channel on the X2-interface; an air interface channel; a broadcast channel.

11. A method as set forth in claim 9, wherein said shared resource comprises a shared access spectrum.

12. A method as set forth in claim 9, wherein said shared resource is shared between the at least one network node and a primary user of said shared resource, and wherein said information indicates a reservation zone which has been reserved by said primary user.

13. A method as set forth in claim 9, wherein said information corn information about a resource part to which said information relates.

14. A method as set forth in claim 9, wherein said information comprises timing information as to when said use of said at least one part of the shared resource is one of permitted; to be continued; to be discontinued by at least one network node.

15. A method as set forth in claim 14, wherein when use of said at least part of the shared resource is to be discontinued by said at least one network node, said timing information indicates a time in which said at least one network node may handover its users of said shared resource.

16. A method as set forth in claim 9, wherein said information comprises a transaction identifier to enable said at least one network node to determine whether said information has already been received.

17. An apparatus:
said apparatus configured to operate with a shared resource;
wherein said apparatus is configured to receive information from one or at least two network nodes;
wherein said apparatus is configured to determine from said information that use of at least part of said shared resource is one of: permitted at said apparatus; to be continued at said apparatus; to be discontinued at said apparatus.

18. An apparatus as set forth in claim 17, wherein said apparatus is configured to receive said information on one or at least two of: a c-plane communication channel; an m-plane communication channel; a communication channel on the X2-interface; an air interface channel; a broadcast channel.

19. An apparatus as set forth in claim 17 wherein said shared resource with which said apparatus is configured to operate comprises a shared access spectrum.

20. An apparatus as set forth in claim 17, wherein said apparatus is configured to share said shared resource with a primary user of said shared resource, and wherein said information indicates a reservation zone which has been reserved by said primary user.

21. An apparatus as set forth in claim 17, wherein said information comprises information about a resource part to which said information relates.

22. An apparatus as set forth in claim 17, wherein said information comprises timing information, and said apparatus is configured to use said timing information to determine a time that use of said shared resource is one of permitted at said apparatus; to be continued at said apparatus; to be discontinued at said apparatus.

23. An apparatus as set forth in claim 22, wherein when use of said shared resource is to be discontinued by said apparatus, said apparatus is configured to use said timing information to determine a time in which said apparatus may handover its users of said shared resource.

24. An apparatus as set forth in claim 17, wherein said information comprises a transaction identifier, said apparatus being configured to use said transaction identifier to determine whether said information has already been received at said apparatus.

25. An apparatus as set forth in claim 17, wherein said apparatus comprises a base station.

26. An apparatus:
wherein said apparatus is configured to send information to at least one network node operating with a shared resource;
wherein said information comprises information that use of at least a part of said shared resource is one of: permitted at at least one network node; to be continued by at least one network node; to be discontinued by at least one network node;
and wherein said apparatus is configured to send said information on one or at least two communication channels.

27. An apparatus as set forth in claim 26, wherein said apparatus is configured to send said information on one or at least two of: a c-plane communication channel; an m-plane communication channel; a communication channel on the X2-interface; an air interface channel; a broadcast channel.

28. An apparatus as set forth in claim 26, wherein said shared resource comprises a shared access spectrum.

29. An apparatus as set forth in claim 26, wherein said shared resource is shared between at least a first node and a primary user of said shared resource, and wherein said apparatus is configured to include an indicator in said information of a reservation zone which has been reserved by said primary user.

30. An apparatus as set forth in claim 26, wherein said apparatus is configured to provide information about a resource part to which said information relates.

31. An apparatus as set forth in claim 26, wherein said apparatus is configured to provide timing information as to when said use of said at least part of the shared resource is one of: permitted at at least one network node; to be continued by at least one network node; to be discontinued by at least one network node.

32. An apparatus as set forth in claim 31, wherein when use of said shared resource is to be discontinued by said at least one network node, said timing information indicates a time in which said at least one network node may handover its users of said shared resource.

33. An apparatus as set forth in claim 26, wherein said apparatus is configured to provide a transaction identifier associated with said information to enable said at least one network node to determine whether said information has already been received.

34. An apparatus as set forth in claim 26, wherein said apparatus comprises an Authorised Shared Access/Licensed Shared Access Control node.

35. A system comprising:
an apparatus configured to send information to at least one network node operating with a shared resource;
at least one network apparatus configured to receive said information and to determine whether use of at least part of said shared resource is one of: permitted at said network apparatus; to be continued at said network apparatus; to be discontinued at said network apparatus.

36. A computer program comprising computer executable instructions which when run on one or more processors perform the method of claim 1.

37. A computer program comprising computer executable instructions which when run on one or more processors perform the method of claim 9.
